(19) United States
(12) Patent Application Publication
(10) Pub. No.: US 2006/0190967 A1
(43) Pub. Date: Aug. 24, 2006

(54) Multi-channel satellite signal receiving apparatus

(76) Inventor: Michael Anthony Pugel, Noblesville, IN (US)

Correspondence Address: THOMSON LICENSING INC., PATENT OPERATIONS, PO BOX 5312, PRINCETON, NJ, 08543-5312, US

(21) Appl. No.: 10/548,635

(22) PCT Filed: Mar. 5, 2004
(86) PCT No.: PCT/US04/06976

§ 371 Date: Sep. 9, 2005

Related U.S. Application Data
(60) Provisional application No. 60/453,359, filed on Mar. 10, 2003.

(51) Int. Cl. H04N 7/20

(52) U.S. Cl. 725/63; 725/69; 725/70

(57) ABSTRACT

A multi-channel satellite signal receiving apparatus is capable of simultaneously providing broadcast programs from a plurality of different sets of transponders in a satellite broadcast system. According to an exemplary embodiment, the multi-channel satellite signal receiving apparatus includes an input operative to receive input signals via a single cable from a predetermined frequency band having a first sub-band and a second sub-band. The first sub-band includes first signals which previously exhibited a first polarization provided from a first set of transponders, and the second sub-band includes second signals which previously exhibited a second polarization provided from a second set of transponders. Signal processing circuitry is operative to simultaneously provide a plurality of digital transport streams corresponding to the first and second sets of transponders responsive to the first and second signals.

The present invention generally relates to multi-channel signal receivers, and more particularly, to a multi-channel satellite signal receiving apparatus which is capable of simultaneously providing broadcast programs from a plurality of different sets of transponders in a satellite broadcast system.

In a satellite broadcast system, a satellite receives signals representing audio, video, and/or data information from an earth-based transmitter. The satellite amplifies and rebroadcasts these signals to a plurality of satellite signal receivers, located at the residences of consumers, via transponders operating at specified frequencies and having given bandwidths. Such a system includes an uplink transmitting portion (i.e., earth to satellite), an earth-orbiting satellite signal receiving and transmitting unit, and a downlink portion (i.e., satellite to earth) including one or more satellite signal receivers located at the residences of consumers.

At least one existing satellite broadcast system operates in a manner such that a first set of transponders apply a first polarization (e.g., right hand circular polarization) to the signals broadcast from its transponders, while a second set of transponders apply a second and opposite polarization (e.g., left hand circular polarization) to the signals broadcast from its transponders. With current satellite signal receivers, a problem exists in that a given satellite signal receiver is unable to simultaneously receive signals from both the first and second sets of transponders. In particular, a typical satellite antenna system employs a low noise block converter (LNB) which selectively provides broadcast signals to a given satellite signal receiver from either the first set of transponders, or the second set of transponders, but not both sets of transponders at the same time. Accordingly, the given satellite signal receiver cannot access broadcast programs provided from both sets of transponders at the same time. As a result, if a user provides a channel change command to switch from a broadcast program provided from the first set of transponders to another broadcast program provided from the second set of transponders, the given satellite signal receiver must switch the LNB between the first and second sets of transponders, which may in turn increase channel change times. Another key problem with such satellite signal receivers is that users cannot watch a broadcast program provided from the first set of transponders, and simultaneously record another broadcast program provided from the second set of transponders. One common approach to addressing the foregoing problems is to simply run two cables (i.e., one for each set of transponders) from the LNB to the satellite signal receiver. This approach, however, tends to be impractical and costly for the user, and is therefore not desirable.

Accordingly, there is a need for a multi-channel satellite signal receiving apparatus which avoids the foregoing problems, and also simultaneously provides broadcast programs from a plurality of different sets of transponders in a satellite broadcast system.

In accordance with an aspect of the present invention, a multi-channel receiving apparatus is disclosed. According to an exemplary embodiment, the multi-channel receiving apparatus comprises input means for receiving input signals via a single cable from a predetermined frequency band having a first sub-band and a second sub-band. The first sub-band includes first signals which previously exhibited a first polarization provided from a first set of transponders, and the second sub-band includes second signals which previously exhibited a second polarization provided from a second set of transponders. Processing means simultaneously provide a plurality of digital transport streams corresponding to the first and second sets of transponders responsive to the first and second signals.

In accordance with another aspect of the present invention, a method for operating a multi-channel satellite signal receiving apparatus is disclosed. According to an exemplary embodiment, the method comprises steps of receiving input signals via a single cable from a predetermined frequency band having a first sub-band and a second sub-band. The first sub-band includes first signals which previously exhibited a first polarization provided from a first set of transponders, and the second sub-band includes second signals which previously exhibited a second polarization provided from a second set of transponders. The first and second signals are processed to simultaneously provide a plurality of digital transport streams corresponding to the first and second sets of transponders.

The above-mentioned and other features and advantages of this invention, and the manner of attaining them, will become more apparent and the invention will be better understood by reference to the following description of embodiments of the invention taken in conjunction with the accompanying drawings, wherein:

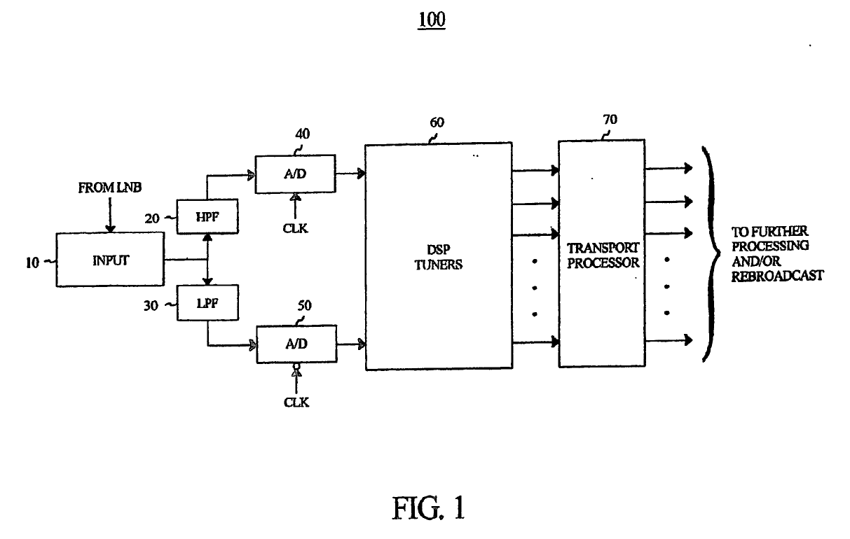

FIG. 1 is a block diagram of a multi-channel satellite signal receiving apparatus according to an exemplary embodiment of the present invention;

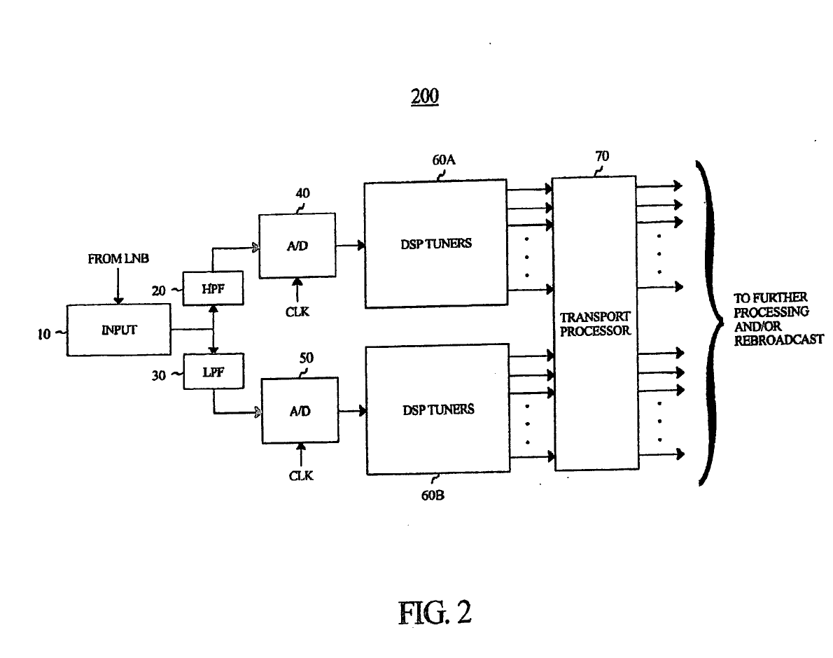

FIG. 2 is a block diagram of a multi-channel satellite signal receiving apparatus according to another exemplary embodiment of the present invention; and

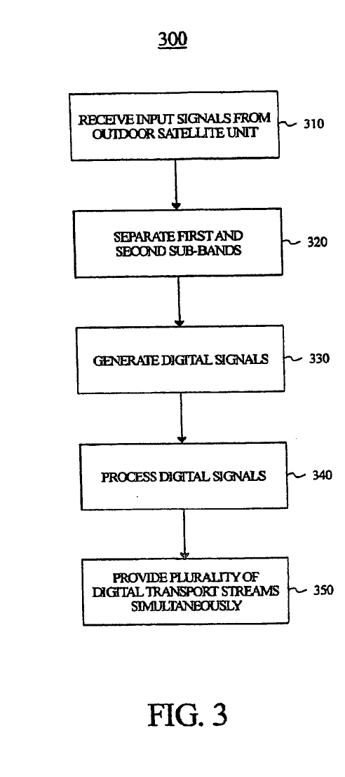

FIG. 3 is a flowchart illustrating steps according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, a block diagram of a multi-channel satellite signal receiving apparatus 100 according to an exemplary embodiment of the present invention is shown. As shown in FIG. 1, multi-channel satellite signal receiving apparatus 100 comprises input means such as input block 10, and processing means such as signal processing circuitry 20 to 70. Signal processing circuitry 20 to 70 includes first filtering means such as high pass filter (HPF) 20, second filtering means such as low pass filter (LPF) 30, first analog-to-digital (A/D) converting means such as first A/D converter 40, second A/D converting means such as second A/D converter 50, digital signal processing means such as digital signal processing (DSP) tuners 60, and transport processing means such as transport processor 70. The foregoing elements of FIG. 1 may be embodied using integrated circuits (ICs), and any given element may for example be included on one or more ICs. For clarity of description, certain conventional elements associated with multi-channel satellite signal receiving apparatus 100 such as certain control signals, power signals and/or other elements may not be shown in FIG. 1.

Input block 10 is operative to receive input signals from an LNB of an outdoor unit via a single cable, such as an RG-6 type coaxial cable, and/or other type of cable. According to an exemplary embodiment, the input signals received by input block 10 occupy a predetermined frequency band of 950 to 2150 MHz and include first signals in a first sub-band from 950 to 1450 MHz and second signals in a second sub-band from 1650 to 2150 MHz. According to this exemplary embodiment, the first signals in the first sub-band previously exhibited a first polarization (e.g., right hand circular polarization) provided from a first set of transponders, and the second signals in the second sub-band previously exhibited a second polarization (e.g., left hand circular polarization) provided from a second set of transponders. The LNB of the outdoor unit processes the first and second signals as provided by the first and second sets of transponders in order to place them in the first and second sub-bands, respectively. Also according to this exemplary embodiment, there are a total of 32 transponders and the first set of transponders includes odd numbered transponders (e.g., 1, 3, 5 . . . 31), while the second set of transponders includes even numbered transponders (e.g., 2, 4, 6 . . . 32). In practice, however, the total number of transponders may differ. The first and second sets of transponders referred to herein may for example represent all, or substantially all, of the transponders operating in a given satellite broadcast system, which may include one or more satellites. Input block 10 may also be operative to perform certain known processing operations, such as signal amplification, automatic gain control, filtering and/or other operations.

HPF 20 is operative to perform a high pass filtering operation to thereby separate the first and second sub-bands. According to an exemplary embodiment, HPF 20 is operative to pass signals having a frequency greater than 1550 MHz. Accordingly, HPF 20 passes signals from the second sub-band (e.g., 1650 to 2150 MHz), while blocking signals from the first sub-band (e.g., 950 to 1450 MHz). LPF 30 is operative to perform a low pass filtering operation to also separate the first and second sub-bands. According to an exemplary embodiment, LPF 30 is operative to pass signals having a frequency less than 1550 MHz. Accordingly, LPF 30 passes signals from the first sub-band (e.g., 950 to 1450 MHz), while blocking signals from the second sub-band (e.g., 1650 to 2150 MHz).

First A/D converter 40 is operative to convert the signals provided from HPF 20 from an analog format to a digital format, thereby generating digital signals from the second sub-band. Second A/D converter 50 is operative to digitize the signals provided from LPF 30 from an analog format to a digital format, thereby generating digital signals from the first sub-band. According to an exemplary embodiment, a common clock (CLK) controls first and second A/D converters 40 and 50. Also according to an exemplary embodiment, the common clock (CLK) exhibits a frequency which is between the first and second sub-bands. For example, the common clock (CLK) may exhibit a frequency of 1550 MHz. As indicated in FIG. 1, first and second A/D converters 40 and 50 each operate on different edges of the common clock (CLK). Although not expressly shown in FIG. 1, a multiplexer may be added to receive the digital signals provided from first and second A/D converters 40 and 50 in order to combine the digital signals into a single digital stream.

DSP tuners 60 are operative to process the digital signals provided from first and second A/D converters 40 and 50 to thereby generate a plurality of digitally processed signal streams in a simultaneous manner. According to an exemplary embodiment, DSP tuners 60 are operative to perform various processing functions including digital tuning (e.g., multi-channel frequency downconversion), digital filtering, decimation, digital demodulation (e.g., Quadrature Phase Shift Keyed (QPSK), Quadrature Amplitude Modulation (QAM), and/or other types of demodulation), and Forward Error Correction (FEC) decoding functions. Also according to an exemplary embodiment, DSP tuners 60 operate on both edges of the common clock (CLK), and thereby exhibit twice the processing speed of first and second A/D converters 40 and 50. According to this exemplary embodiment, each of the digitally processed signal streams provided from DSP tuners 60 corresponds to a given transponder, and may include a plurality of time-division multiplexed broadcast programs.

Transport processor 70 is operative to process the digitally processed signal streams provided from DSP tuners 60 to thereby generate and output a plurality of digital transport streams in a simultaneous manner. As previously indicated herein, each of the digitally processed signal streams provided from DSP tuners 60 corresponds to a given transponder. Accordingly, with a satellite broadcast system having a total of 32 transponders, transport processor 70 will receive 32 different digitally processed signal streams as inputs. According to an exemplary embodiment, transport processor 70 demultiplexes these digitally processed signal streams into a plurality of digital transport streams which each includes a broadcast program. In this manner, broadcast programs provided from both the first and second sets of transponders may be accessed in a simultaneous manner. Although not expressly shown in FIG. 1, transport processor 70 may include an input select function which enables one or more of the digital transport streams to be selectively output. As indicated in FIG. 1, the digital transport streams output from transport processor 70 may be provided for further processing (e.g., digital decoding, etc.), and/or may be rebroadcast to one or more other devices.

FIG. 2 shows a block diagram of a multi-channel satellite signal receiving apparatus 200 according to another exemplary embodiment of the present invention. As indicated in FIG. 2, multi-channel satellite signal receiving apparatus 200 includes several elements which are the same as or similar to elements of multi-channel satellite signal receiving apparatus 100 of FIG. 1, and such elements are represented by the same reference numbers in both FIGS. 1 and 2. For clarity of description, these common elements will not be described again, and the reader may refer to the description of these elements previously provided herein.

In FIG. 2, multi-channel satellite signal receiving apparatus 200 includes two separate DSP tuners 60A and 60B which are operative to process the digital signals provided from first and second A/D converters 40 and 50, respectively, to thereby generate a plurality of digitally processed signal streams in a simultaneous manner. According to an exemplary embodiment, DSP tuners 60A and 60B are each operative to perform various processing functions including digital tuning (e.g., multi-channel frequency downconversion), digital filtering, decimation, digital demodulation (e.g., QPSK, QAM, and/or other types of demodulation), and FEC decoding functions. With the exemplary embodiment of FIG. 2, DSP tuners 60A provide digitally processed signal streams corresponding to the first set of transponders (e.g., odd numbered transponders), while DSP tuners 60B provide digitally processed signal streams corresponding to the second set of transponders (e.g., even numbered transponders). Also with the exemplary embodiment of FIG. 2, A/D converters 40 and 50 may each operate on the same edge of the common clock (CLK).

To facilitate a better understanding of the inventive concepts of the present invention, an example will now be provided. Referring to FIG. 3, a flowchart 300 illustrating steps according to an exemplary embodiment of the present invention is shown. For purposes of example and explanation, the steps of FIG. 3 will be described with reference to multi-channel satellite signal receiving apparatuses 100 and 200 of FIGS. 1 and 2. The steps of FIG. 3 are merely exemplary, and are not intended to limit the present invention in any manner.

At step 310, multi-channel satellite signal receiving apparatus 100/200 receives input signals from the LNB of an outdoor satellite unit. According to an exemplary embodiment, input block 10 receives the input signals at step 310 and the received input signals occupy a predetermined frequency band of 950 to 2150 MHz having a first sub-band from 950 to 1450 MHz and a second sub-band from 1650 to 2150 MHz. According to this exemplary embodiment, the first sub-band includes first signals which previously exhibited the first polarization (e.g., right hand circular polarization) provided from the first set of transponders (e.g., odd numbered transponders), and the second sub-band includes second signals which previously exhibited the second polarization (e.g., left hand circular polarization) provided from the second set of transponders (e.g., even numbered transponders). As previously indicated herein, the first and second sets of transponders may for example represent all, or substantially all, of the transponders operating in a given satellite broadcast system, which may include one or more satellites.

At step 320, multi-channel satellite signal receiving apparatus 100/200 separates the first and second sub-bands. According to an exemplary embodiment, HPF 20 and LPF 30 each separate the first and second sub-bands at step 320 using high pass and low pass filtering operations, respectively. According to this exemplary embodiment, HPF 20 passes signals from the second sub-band (e.g., 1650 to 2150 MHz), while blocking signals from the first sub-band (e.g., 950 to 1450 MHz), while LPF 30 passes signals from the first sub-band (e.g., 950 to 1450 MHz), while blocking signals from the second sub-band (e.g., 1650 to 2150 MHz).

At step 330, multi-channel satellite signal receiving apparatus 100/200 generates digital signals corresponding to the first and second sub-bands. According to an exemplary embodiment, first and second A/D converters 40 and 50 generate the digital signals at step 330 by digitizing the signals provided from HPF 20 and LPF 30, respectively. In this manner, first A/D converter 40 generates digital signals corresponding to the first sub-band, while second A/D converter 50 generates digital signals corresponding to the second sub-band.

At step 340, multi-channel satellite signal receiving apparatus 100/200 processes the digital signals generated at step 330 to thereby generate a plurality of digitally processed signal streams in a simultaneous manner. According to an exemplary embodiment, DSP tuners 60 process the digital signals at step 340 by performing various processing functions including digital tuning (e.g., multi-channel frequency downconversion), digital filtering, decimation, digital demodulation (e.g., QPSK, QAM, and/or other types of demodulation), and FEC decoding functions. As previously indicated herein, each of the digitally processed signal streams generated by DSP tuners 60 corresponds to a given transponder, and may include a plurality of time-division multiplexed broadcast programs.

At step 350, multi-channel satellite signal receiving apparatus 100/200 provides a plurality of digital transport streams in a simultaneous manner. According to an exemplary embodiment, transport processor 70 demultiplexes the digitally processed signal streams provided from DSP tuners 60 to thereby provide the plurality of digital transport streams in a simultaneous manner at step 350. As previously indicated herein, each of the digital transport streams provided from transport processor 70 may include a broadcast program. In this manner, broadcast programs from both the first and second sets of transponders may be accessed in a simultaneous manner.

As described herein, the present invention provides a multi-channel satellite signal receiving apparatus which is capable of simultaneously providing broadcast programs from a plurality of different sets of transponders in a satellite broadcast system. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A multi-channel satellite signal receiving apparatus, comprising:
input means for receiving input signals via a single cable from a predetermined frequency band having a first sub-band and a second sub-band, said first sub-band including first signals which previously exhibited a first polarization provided from a first set of transponders, and said second sub-band including second signals which previously exhibited a second polarization provided from a second set of transponders; and
processing means for simultaneously providing a plurality of digital transport streams corresponding to said first and second sets of transponders responsive to said first and second signals.

2. The multi-channel satellite signal receiving apparatus of claim 1, wherein each of said digital transport streams includes a broadcast program.

3. The multi-channel satellite signal receiving apparatus of claim 1, wherein:
said first sub-band is approximately 950 to 1450 MHz; and
said second sub-band is approximately 1650 to 2150 MHz.

4. The multi-channel satellite signal receiving apparatus of claim 1, wherein:
said first set of transponders includes odd numbered transponders; and
said second set of transponders includes even numbered transponders.

5. The multi-channel satellite signal receiving apparatus of claim 1, wherein said processing means includes filtering means for separating said first and second sub-bands.

6. The multi-channel satellite signal receiving apparatus of claim 5, wherein said filtering means includes a high pass filter and a low pass filter.

7. The multi-channel satellite signal receiving apparatus of claim 1, wherein said processing means includes:
first analog-to-digital converting means for performing a first analog-to-digital conversion;
second analog-to-digital converting means for performing a second analog-to-digital conversion; and
wherein a common clock controls said first and second analog-to-digital converting means.

8. The multi-channel satellite signal receiving apparatus of claim 7, wherein said common clock exhibits a frequency between said first and second sub-bands.

9. A method for operating a multi-channel satellite signal receiving apparatus, comprising steps of:
receiving input signals via a single cable from a predetermined frequency band having a first sub-band and a second sub-band, said first sub-band including first signals which previously exhibited a first polarization provided from a first set of transponders, and said second sub-band including second signals which previously exhibited a second polarization provided from a second set of transponders; and
processing said first and second signals to simultaneously provide a plurality of digital transport streams corresponding to said first and second sets of transponders.

10. The method of claim 9, wherein each of said digital transport streams includes a broadcast program.

11. The method of claim 9, wherein:
said first sub-band is approximately 950 to 1450 MHz; and
said second sub-band is approximately 1650 to 2150 MHz.

12. The method of claim 9, wherein:
said first set of transponders includes odd numbered transponders; and
said second set of transponders includes even numbered transponders.

13. The method of claim 9, wherein said processing step includes a filtering operation for separating said first and second sub-bands.

14. The method of claim 13, wherein said filtering operation includes a high pass filtering operation and a low pass filtering operation.

15. The method of claim 9, wherein said processing step includes:
performing a first analog-to-digital conversion;
performing a second analog-to-digital conversion; and
wherein a common clock controls said first and second analog-to-digital conversions.

16. The method of claim 15, wherein said common clock exhibits a frequency between said first and second sub-bands.

17. A multi-channel satellite signal receiving apparatus comprising:
an input (10) operative to receive input signals via a single cable from a predetermined frequency band having a first sub-band and a second sub-band, said first sub-band including first signals which previously exhibited a first polarization provided from a first set of transponders, and said second sub-band including second signals which previously exhibited a second polarization provided from a second set of transponders; and
signal processing circuitry operative to simultaneously provide a plurality of digital transport streams corresponding to said first and second sets of transponders responsive to said first and second signals.

18. The multi-channel satellite signal receiving apparatus of claim 17, wherein each of said digital transport streams includes a broadcast program.

19. The multi-channel satellite signal receiving apparatus of claim 17, wherein:
said first sub-band is approximately 950 to 1450 MHz; and
said second sub-band is approximately 1650 to 2150 MHz.

20. The multi-channel satellite signal receiving apparatus of claim 17, wherein:
said first set of transponders includes odd numbered transponders; and
said second set of transponders includes even numbered transponders.

21. The multi-channel satellite signal receiving apparatus of claim 17, wherein said signal processing circuitry includes filtering circuitry operative to separate said first and second sub-bands.

22. The multi-channel satellite signal receiving apparatus of claim 21, wherein said filtering circuitry includes a high pass filter and a low pass filter.

23. The multi-channel satellite signal receiving apparatus of claim 17, wherein said signal processing circuitry includes:
a first analog-to-digital converter operative to perform a first analog-to-digital conversion;
a second analog-to-digital converter operative to perform a second analog-to-digital conversion; and
wherein a common clock controls said first and second analog-to-digital converters.

24. The multi-channel satellite signal receiving apparatus of claim 23, wherein said common clock exhibits a frequency between said first and second sub-bands.
